(19) United States
(12) Patent Application Publication
(10) Pub. No.: US 2003/0196358 A1
(43) Pub. Date: Oct. 23, 2003

(54) Pizza advertizing and delivery beacon

(76) Inventor: Frank V. Fratzke, Newport News, VA (US)

Correspondence Address: SHOEMAKER AND MATTARE, LTD, SUITE 1203, 2001 JEFFERSON DAVIS HIGHWAY, ARLINGTON, VA, 22202, US

(21) Appl. No.: 10/418,091

(22) Filed: Apr. 18, 2003

Related U.S. Application Data
(60) Provisional application No. 60/373,581, filed on Apr. 19, 2002.

(51) Int. Cl. G09F 7/00; G09F 13/02

(52) U.S. Cl. 40/597; 40/559

(57) ABSTRACT

A vendor such as a pizza parlor promotes its products and improves its service by providing to customers, free of charge, distinctive beacons which can be placed in the window of a home to attract a delivery person. The vendor induces customers to use the beacon by offering discounts and faster delivery service, and benefits from having its advertizing prominently displayed in homes.

This application claims benefit under 35 USC 119(e) from provisional U.S. Patent Application No. 60/373,581 filed Apr. 19, 2002.

### BACKGROUND OF THE INVENTION

This invention relates to a method and device for identifying delivery locations for vendors such as home delivery pizza vendors, and for providing advertising space on the device for such vendors.

Prior inventors have developed devices which can be hung in the window of one's home to attract emergency vehicles or delivery men. Examples are disclosed in U.S. Pat. Nos. 5,135,760, 5,103,581 and 6,098,326, and U.S. Design Pat. No. D444817.

### SUMMARY OF THE INVENTION

An object of this invention to provide food franchises and businesses of the type that typically deliver their products to homes and businesses a way to advertise their products by displaying their logos, phone numbers, or other advertising information on a device including a beacon.

Another object of the invention is to combine advertising found on the beacon with related discounts and promotions tied to its usage, and further to provide branding capabilities to businesses who use the beacon.

The invention aims to provide for delivery persons an easily seen signal to identify a target delivery location. A related goal is to improve delivery efficiency by reducing the amount of time required to find the delivery location, and thus to reduce delivery costs.

Other goals are to improve the speed and safety of the food delivery process, and to enhance the ability to advertise a particular food provider, to enhance customer loyalty, and to promote brand recognition.

A further object of this invention is to allow for simple manufacture and assembly of a delivery beacon, thereby making the product attractive for food franchises to distribute, sell, or provide at low—or no—cost to their customers for use in sales promotions and advertising.

The invention provides a flashing strobe in different colors, to allow for greater branding potential for the various food vendors. For example, red may represent one vendor, green another, and blue yet another vendor.

An additional object of the invention is to provide great flexibility, by permitting the components of the invention to be combined in various ways and thus customized in terms of not only the shape and appearance of the device, but also images, logos, coupons, advertising, or instructions printed on it. The goal is to enhance the ability of vendors to make the device in a form unique to their brand, and to control costs per unit.

A further object of the invention is to allow each individual instance to be serially, digitally, or optically encoded, so that the delivery person, or the vendor can uniquely identify that unit and track its usage.

Another object of the invention is to provide a device which can be easily hung from an exterior doorknob, mailbox, window, hook or protrusion. A related object is to permit attachment of the device to a window or other smooth surface.

In another form of the invention an additional object of the invention is to provide a form that can be placed on a flat surface, the hood of a car, a window sill, or on the ground

These and other objects are attained by a pizza delivery beacon, and a method of using it, as described below.

### BRIEF DESCRIPTION OF THE DRAWING

In the accompanying drawing,

FIG. 1 is a front elevation of a pizza delivery beacon embodying the invention, and

FIG. 2 is a side elevation thereof

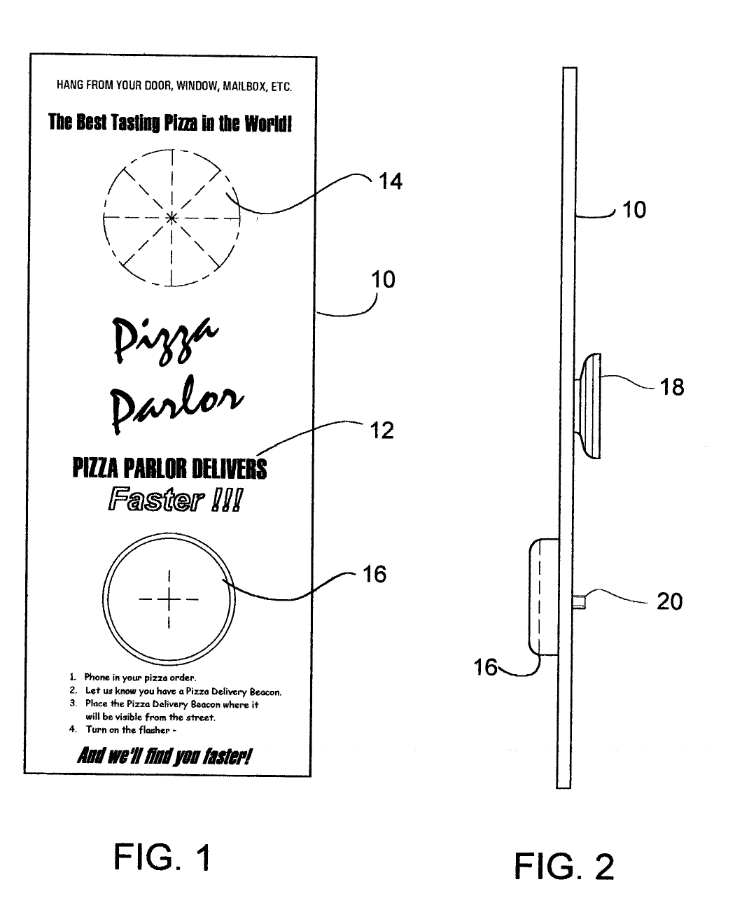

### DESCRIPTION OF THE PREFERRED EMBODIMENT

A pizza delivery beacon embodying the invention is made up of three components (see FIG. 2), two of which may be adaptable based on user needs.

The first part 10 is a body, preferably a panel of material which may be imprinted with advertising 12, having a hole or hook 14 for hanging from a door knob or the like. The panel portion receives the other two components, namely a flasher 16, and a suction cup 18. The panel can be made of cardboard, plastic, cloth, felt, or other durable and flexible material. The panel is imprinted with advertising and instructional copy. A presently preferred size is about 4¼×11″ (10.8 mm×27.9 mm), but the size of the panel may vary depending on the amount of advertising copy a particular business may require.

The panel may be die cut to accept a flasher unit 16, and to provide access to the flasher unit's on-off switch 20.

The body of the beacon can be made of various materials including, paper, cardboard, Mylar, Tyvec, plastic, cloth, felt, glow-in-the-dark materials, or any materials suitable for cutting and printing, and having the ability to receive the flasher unit or units and other hardware such as attaching clips, suction cups, Velcro, etc. Each instance of the beacon need not contain all possible elements.

The shape of the body of the beacon may be rectangular, square, circular, oval, or a shape which furthers the message of the advertisement, or enhances noticeability, e.g., the shape of a building, animal, logo, etc.

The body may alternatively be 3-dimensional, in which case it may be made from folded stock materials, such as paper, cardboard, etc. In addition, the body may be embossed using commercially available embossing techniques. Rather than being made from flat stock material, the body may be a molded item of virtually any shape. It could then be set on a table, the hood of a car, on the ground, etc.

Depending on the shape of the advertising portion, the body can be cut using a custom-made die, or other standard cutting devices typically found in a production printing operation.

The body of the beacon may be perforated to allow portions of the body to be easily torn off, for example, to allow for promotional coupons to be removed and given to the delivery person.

The printing on the panel may contain any message, artwork, or instruction deemed appropriate by the user, particularly advertising, or messages from one or multiple sponsors or users. The printing can be in any combination of commercially available inks, in any combination of colors, including luminescent inks.

The body may also be marked in a serialized fashion, or marked with bar coding which may be used to “scan” the unit so that a record of usage may be recorded thereby allowing promotional, identity, or other data collection information to be obtained about the unit and/or its “owner”.

The second component of the invention is the strobe flasher unit 16, which has a clip (not shown) on its rear surface to allow it to be attached to the hanger/advertising portion. The flasher has an on-off switch (not shown), and preferably has replaceable batteries. A preferred strobe flasher portion which has 100 hours of battery life, will work in a wet environment, and will float. The shape of the strobe can vary, with dimensions generally less than or equal to 2¼″×2¾″ (5.7 mm×7.0 mm).

The strobe light may be round, rectangular, square, or it may be molded into custom or standard shapes. For example, the strobe could be made in the shape of the United States, a logo, a light bulb, a football, a heart, a star, or any regular or irregular polygon.

The strobe should be bright enough to be visible for a quarter mile or more. It may comprise light emitting diodes, incandescent bulbs, or other light sources. The light may be of any desired color and similarly, and the color of the covering of the strobe unit can tinted in any available color. The strobe may or may not have replaceable batteries depending on customer requirements, and it should be weather resistant if outside use is contemplated.

A preferred beacon contains one strobe flasher. However, multiple flashers could be used to provide additional visibility, or to display in lights a name or message depending on the requirements of the vendor or user. In additions the strobe light covering could be structured to selectively let light pass through in such a way that words, logos or other messages appear to be illuminated.

The strobe can be attached to the body by a clip that is part of the strobe, the clip being inserted into a receiving hole in the body. Alternatively, the strobe can be attached using an adhesive that will adhere to both the strobe material and the body material, or by other well-known means, such as adhesive tape or Velcro-type fasteners. The body of the beacon may have a hole through which an operator (e.g. button) of the on/off switch protrudes, or the handle may be concealed within the body below an indicator showing where to press on the body to toggle the switch on and off.

The third, optional, portion of the invention is a suction cup 18 which may be attached to the hanger/advertising portion to allow for placement of the invention in a window, or onto other smooth surfaces. Alternatively, or in addition, the body may have clasps, such as alligator clips, to allow attachment to other items such as curtains, car visors, blinds, etc.

The beacon may also include a small “kit” containing a small strip of Velcro with peel-off adhesive to allow one part of the Velcro to be attached to the body of the delivery beacon, and one part to be attached to another surface to allow the unit to be placed on or attached to virtually any surface.

The device is manufactured as follows:

The body portion is fabricated from paper, cardboard, cloth, felt, or plastic, which is die cut into the appropriate shape to receive the strobe unit, and the suction cup.

The body portion is imprinted with the vendor's advertising, identification marks and instructional messages using standard printing press technologies, high-speed web technologies, laser or ink jet printers, or otherwise, including low volume technologies for smaller jobs.

After choosing the desired strobe shape, the strobe light or lights are attached to the body portion using the clip on the strobe light, by passing the strobe clip through the die cut slot in the body portion. Optionally, the strobe may be attached with a suitable adhesive, with hook-and-loop fasteners (“Velcro”), or by other means.

In a like manner, the suction cup is attached to the body portion; alternatively, it may be left unattached for the end user to apply, if desired.

Because the delivery beacon can be manufactured at a very low unit cost, the preferred distribution method is to have the vendor purchase the units, and then to provide the beacon at no charge or at low cost to the end users.

In use, a business providing delivery service—such as a pizza parlor—delivers a first order of goods or services to a customer's home. At that time, if the delivery person does not notice a delivery beacon at the home, he gives the customer a free delivery beacon and encourages him to use it next time. The encouragement may be augmented by the promise of a discount, or other inducement, if the beacon is set out for future deliveries. Alternatively, the vendor may hang the delivery beacon on the front door or mailbox of all homes or businesses in a particularly targeted area to encourage its use, and to encourage all recipients to purchase goods from that vendor. The delivery beacon may also be given away at the vendor's store location or elsewhere, or it may be mailed or otherwise delivered directly to intended end-users of the beacon. As the delivery beacons become worn, outdated, or otherwise non-functional, replacements can be delivered in a like manner.

After placing an order with the vendor, the customer activates the strobe portion of the beacon, and places it where it will be seen by the approaching delivery person. The vendor may remind the customer, when the order is placed, to use the beacon, and to review any discounts or promotions associated with usage of the beacon, and may also advise the customer that the beacon may produce faster delivery. If the vendor determines that the user does not have a beacon, one is offered at the time of delivery.

Upon making delivery, the delivery person retrieves the beacon, scans or records its use if necessary, turns off the flasher, and returns it to the customer for use in the next delivery cycle.

Discounts associated with the use of the beacon may be in the form of reduced cost per use; or coupons may be torn from the body of the delivery beacon to be redeemed at each use; or the beacon may be punched by the delivery person and the discount can be given after a vendor specified number of uses of the delivery beacon; or the delivery person could optically scan the marking on the delivery beacon, or otherwise manually, or electronically with or without use of a computerized database, record usage of the delivery beacon registering its use and, like the punch method, provide the promotion, discount or discounts at specified usage levels. Delivery people should be instructed to not give any discounts or redemptions related to the delivery beacon unless the beacon is actually used.

At subsequent deliveries, the delivery person is attracted more quickly to the proper house by the beacon. The vendor's business benefits by not having the delivery person waste time looking for the right address, the delivery person's job is made easier, and the customer may get his pizza sooner. The business also may benefit by having its advertising (on the panel portion) visible in the home. Additionally, the vendor's discounts or price reductions for its continuing use of the beacon may enhance customer loyalty. Others, after having seen a neighbor's flashing beacon, may be induced to patronize the vendor, by the branding ability of the delivery beacon.

Since the invention is subject to modifications and variations, it is intended that the foregoing description and the accompanying drawings shall be interpreted as only illustrative of the invention defined by the following claims.

I claim:

1. A pizza delivery beacon comprising
a panel of imprintable material;
a distinctive light mounted on the panel; and
means for hanging the beacon in a door or window of a home, to attract delivery persons.

2. The beacon of claim 1, wherein the light is a strobe light.

3. The beacon of claim 1, further comprising advertizing printed on said panel.

4. A method of doing business comprising steps of
delivering goods or services to a home of a customer,
providing the customer, free of charge, with a device having a distinctive light visible from a distance outside the home and means for mounting the device on a window or door of the home, and
inducing the customer to place the device in a door or window of the home prior to a subsequent delivery.

5. The method of claim 4, wherein the distinctive light is a strobe light.

6. The method of claim 4, wherein the inducing step includes the offering of a discount.

7. The method of claim 4, wherein the inducing step includes offering faster delivery.
